(19) United States
(12) Patent Application Publication
(10) Pub. No.: US 2026/0285422 A1
(43) Pub. Date: Sep. 24, 2026

(54) SYSTEM AND METHOD FOR LATCH ENGAGEMENT DETECTION

(71) Applicant: Torc Robotics, Inc., Blacksburg, VA (US)

(72) Inventors: William Gray Davis, Austin, TX (US); Akshay Pal Raikar, Austin, TX (US); Nicholas Atanasov, Austin, TX (US); Pablo Smith, Spicewood, TX (US)

(21) Appl. No.: 19/088,218

(22) Filed: Mar. 24, 2025

(51) Int. Cl. B62D 53/08; B62D 53/12

(52) U.S. Cl. CPC B62D 53/0857; B62D 53/0842; B62D 53/12

(57) ABSTRACT

A system for latch engagement detection is provided. The system includes a latch unit configured to be located on a vehicle. The latch unit includes a passage leading to an interior section configured to receive a kingpin of a trailer. The system includes a locking jaw configured to be positioned into an open position or a closed position to selectively allow or prevent passage of the kingpin into or out of the interior section. The system includes a sensor configured to be located on the vehicle and a processing device in communication with the sensor. The processing device is configured to detect with the at least one sensor at least one of movement of the kingpin of the trailer through the passage and into the interior section of the latch unit, or movement of the locking jaw into the closed position.

### TECHNICAL FIELD

The field of the disclosure relates to latch engagement detection and, in particular, to a system for automatically determining if a kingpin of a trailer has been engaged with a latch unit associated with a vehicle, and verifying such engagement.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. These actions undertaken by the vehicle include steering, braking and acceleration.

Some vehicles include a latching assembly configured to engage with a kingpin of a trailer such that the vehicle can pull the trailer. For autonomous vehicles, there is generally no means for ensuring proper engagement between the latching assembly and the kingpin without human intervention. A human is generally needed to either manually actuate a latching mechanism to engage with the kingpin, or to manually verify that the trailer is properly connected to the vehicle. Manually overseeing and verifying the engagement process can be time-consuming and can prevent the vehicle from departing in a timely and efficient manner. However, without this human intervention, an improper engagement between the latching mechanism and the kingpin can occur, which can result in disengagement and damage to surrounding objects.

Accordingly, there exists a need for a system and a method of latch engagement detection for autonomous vehicles that verifies engagement between a latching unit and a kingpin without human intervention. These and other needs are met by the exemplary system for latch engagement detection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for latch engagement detection is provided. The system includes a latch unit configured to be located on a vehicle. The latch unit includes a passage leading to an interior section configured to receive a kingpin of a trailer. The system includes a locking jaw of the latch unit configured to be positioned into an open position or a closed position. In the open position, the passage leading to the interior section of the latch unit is unobstructed for passage of the kingpin into and out of the interior section. In the closed position, the passage leading to the interior section of the latch unit is blocked to prevent passage of the kingpin out of the interior section. The system includes at least one sensor configured to be located on the vehicle. The system includes a processing device in communication with the at least one sensor. The processing device is configured to execute instructions stored in a memory to perform operations including detecting with the at least one sensor at least one of movement of the kingpin of the trailer through the passage and into the interior section of the latch unit, or movement of the locking jaw into the closed position.

In some embodiments, the system can include an electromagnetic source connected to a fifth wheel body (e.g., a fifth wheel plate) of the latch unit and configured to generate an electromagnetic field in the passage of the latch unit when in the closed position. Movement of the kingpin of the trailer through the electromagnetic field in the passage of the latch unit changes the electromagnetic field. In some embodiments, detecting with the at least one sensor movement of the kingpin of the trailer through the passage and into the interior section of the latch unit can include detecting a change in the electromagnetic field as the kingpin moves through the electromagnetic field.

In such embodiments, a first electromagnetic field signal can be indicative of the passage being free of the kingpin, a second electromagnetic field signal can be indicative of the kingpin being partially positioned within the passage and spaced from the interior section, and a third electromagnetic field signal can be indicative of the kingpin being positioned in the interior section of the latch unit. Upon detection with the at least one sensor the third electromagnetic field signal, the operations can include actuating the locking jaw into the closed position to prevent passage of the kingpin out of the interior section.

In some embodiments, the system can include an electrical current source passing an electrical current through the latch unit and the locking jaw to form a circuit. In such embodiments, the operations can include detecting with the at least one sensor an open circuit when the locking jaw is in the open position, and detecting with the at least one sensor a closed circuit when the locking jaw is in the closed position extending across and connecting opposing sides of the passage.

In some embodiments, the at least one sensor can be a proximity sensor including at least one of a capacitive sensor, an inductive sensor, a magnetic sensor (e.g., a Hall effect sensor), a contact sensor, or combinations thereof. The sensor is configured to detect changes in physical properties, including but not limited to, magnetic fields, capacitance, the open/closed state of a circuit, and/or a physical interaction with a locking surface. Capacitive proximity sensors can detect variations in capacitance resulting from the presence or movement of nearby objects, where changes in the dielectric properties of the environment alter the sensor's detection field. Inductive proximity sensors can detect the presence of conductive materials by measuring variations in impedance, which are induced by the interaction of the material with an alternating magnetic field generated by the sensor. Magnetic proximity sensors can detect variations in magnetic fields, including shifts in field strength or direction, typically caused by the presence of a magnetized object. Contact sensors are configured to detect physical interaction with an object (e.g., lock jaw or bar), responding to changes in position, force, or displacement of the associated mechanism. These concepts and designs can be incorporated into the exemplary system for operation of the locking jaw in response to the position of the kingpin of the trailer relative to the latch unit.

In some embodiments, the operations can include detecting, with the at least one sensor, a trailer position relative to the vehicle, and aligning the latch unit of the vehicle with the kingpin of the trailer. In some embodiments, the at least one sensor can be at least one of a camera, LiDAR, or combinations thereof. Upon alignment of the latch unit of the vehicle with the kingpin of the trailer, the operations can include releasing air at a rear suspension of the vehicle to lower a rear chassis of the vehicle. The operations can include autonomously reversing the vehicle towards the trailer until the at least one sensor detects the movement of the kingpin of the trailer through the passage and into the interior section of the latch unit. Upon detection with the at least one sensor the movement of the kingpin of the trailer through the passage and into the interior section of the latch unit, the operations can include actuating the locking jaw into the closed position to prevent passage of the kingpin out of the interior section of the latch unit.

In some embodiments, upon detection with the at least one sensor the movement of the kingpin of the trailer through the passage and into the interior section of the latch unit, the operations can include actuating the locking jaw into the closed position to prevent passage of the kingpin out of the interior section of the latch unit. In some embodiments, the operations can include performing a tug test by operating the vehicle to move away from the trailer while a parking brake on the vehicle is released and a parking brake on the trailer is engaged, detecting with the at least one sensor a resistance force on a power train of the vehicle, and comparing the detected resistance force to a predetermined resistance threshold to determine whether engagement between the latch unit and the kingpin is secure. In some embodiments, the operations can include performing a tug test by operating the vehicle to move away from the trailer, detecting with the at least one sensor movement of the trailer, and comparing the detected movement of the trailer relative to a predetermined movement threshold.

In another aspect, an exemplary computer-implemented method for latch engagement detection is provided. The method includes passing a kingpin of a trailer through a passage of a latch unit configured to be located on a vehicle. The latch unit includes the passage leading to an interior section configured to receive the kingpin of the trailer. The latch unit includes a locking jaw configured to be positioned into an open position or a closed position. In the open position, the passage leading to the interior section of the latch unit is unobstructed for passage of the kingpin into and out of the interior section. In the closed position, the passage leading to the interior section of the latch unit is blocked to prevent passage of the kingpin out of the interior section. The method includes executing instructions stored in a memory with a processing device in communication with at least one sensor configured to be located on the vehicle to perform operations including detecting with the at least one sensor at least one of movement of the kingpin of the trailer through the passage and into the interior section of the latch unit, or movement of the locking jaw into the closed position.

In some embodiments, the operations can include generating an electromagnetic field in the passage of the latch unit with an electromagnetic source, and detecting a change in the electromagnetic field during passage of the kingpin of the trailer through the passage. In some embodiments, the operations can include passing an electrical current through the latch unit and the locking jaw with an electrical current source, detecting with the at least one sensor an open circuit when the locking jaw is in the open position, and detecting with the at least one sensor a closed circuit when the locking jaw is in the closed position extending across and connecting opposing sides of the passage.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of the autonomous truck and trailer of FIG. 2.

FIG. 4 is a block diagram of the autonomous truck shown in FIGS. 1-3.

FIG. 5 is a block diagram of an example computing system.

FIG. 6 is a block diagram of an exemplary system for latch engagement detection.

FIG. 7 is a flowchart of a method for latch engagement detection.

FIG. 8 is a diagrammatic, top view of a latch unit of an exemplary system for latch engagement detection, including a locking jaw in an open position and a closed position relative to a kingpin.

FIG. 9 is a diagrammatic, detailed view of the latch unit of FIG. 8.

FIG. 10 is a diagrammatic, detailed view of a sensor of an exemplary system for latch engagement detection, including an internal circuit configured to generate magnetic fields for detection of engagement between a locking jaw and a latch unit.

FIG. 11 is a diagrammatic, detailed view of a sensor of an exemplary system for latch engagement detection, including an internal circuit and a probe core for generating a closed circuit with a latch unit and a locking jaw.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for latch engagement detection provides for an automatic detection of the kingpin position of the trailer relating to a latch unit of the vehicle, which allows for successful engagement and verification between the vehicle and the trailer without human intervention. In some embodiments, the system can include a switch (e.g., a limit switch) to detect when the latching mechanism is fully closed around the kingpin, with the closed circuit indicative of the kingpin position. When the closed circuit signal is received, a signal can be transmitted to the vehicle to indicate that the trailer/load is secure and the vehicle can depart. In some embodiments, the system can include a magnetometer to detect when the latching mechanism is moved from the open position to the closed position. The magnetometer can generate or induce an electromagnetic field through a kingpin female component and a sensor of the system can detect a change in the magnetic field as the latching mechanism travels through the field. When the change in the magnetic field is detected, a signal can be transmitted to the vehicle to indicate that the trailer/load is secure.

In some embodiments, the system can be operated to automatically and autonomously perform an operational test (e.g., a tug test) to determine if the trailer is securely engaged with the vehicle. In particular, the operational test can be used to verify that the latch is properly seated. The operational test can include engaging the parking brake of the trailer while disengaging the vehicle parking brake. The vehicle is then actuated to move forward slightly to “tug” on the trailer to verify that the trailer is properly secured with the latch unit.

In some embodiments, the operational test can include releasing air at the rear suspension of the vehicle to lower the rear chassis. The vehicle is autonomously operated to reverse into the kingpin until the latch release mechanism (e.g., latch unit) is triggered as secure. Other mechanisms, such as LiDAR, radar, cameras, or combinations thereof, can be used to verify the proximity of the vehicle relative to the trailer. Once the kingpin is inserted into the interior section of the latch unit, the locking jaw is actuated into the closed position and the latch engagement check can commence. The vehicle is operated slightly forward and away from the trailer to “tug” on the kingpin with the latch unit.

In some embodiments, during the tug test, a sensor can detect the resistance force on the power trail of the vehicle due to the engaged parking brake of the trailer, and if the resistance force is within a predetermined resistance threshold range, a determination is made that the latch unit is fully engaged. If the resistance force is outside of the predetermined resistance threshold range, e.g., too low, this can indicate that the latch unit is not fully engaged with the kingpin, and realignment and reengagement is needed.

In some embodiments, during a tug test, a sensor can detect if the trailer moves when the vehicle pulls or tugs on the trailer. Any movement of the trailer can be compared to a predetermined movement threshold range to determine if the latch unit is fully engaged. If the movement is outside of the predetermined movement threshold range, e.g., too low, this can indicate that the latch unit is not fully engaged with the kingpin, and realigned and reengagement is needed.

If proper engagement between the kingpin and latch unit is detected, the air springs of the vehicle can be refilled and the trailer landing gear is raised. Mission control can be notified that a full engagement between the vehicle and the trailer has been detected, and the vehicle is ready for departure clearance. The system therefore allows the determination and verification of engagement between the vehicle and the trailer to be performed fully autonomously and automatically without human intervention.

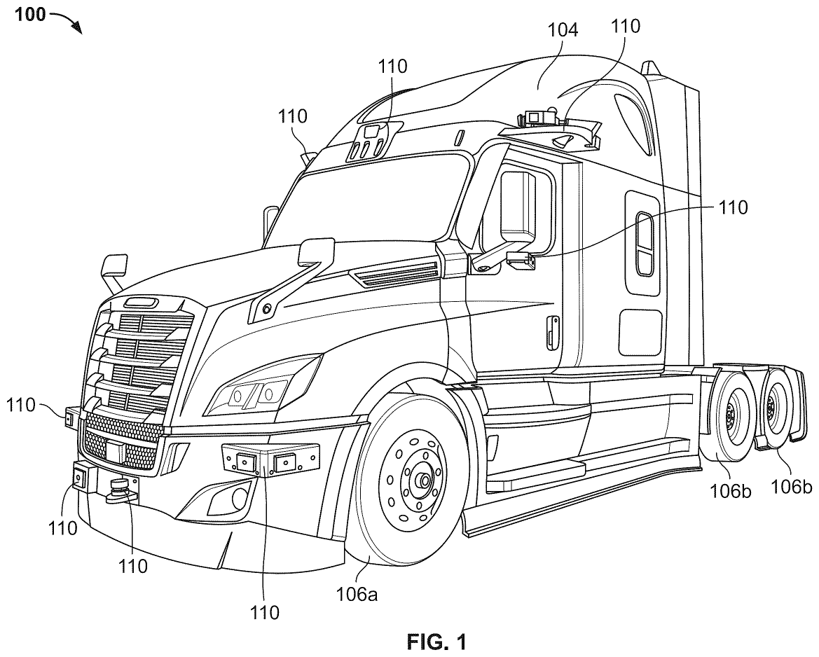

Various embodiments in the present disclosure are described with reference to FIGS. 1-11 below.

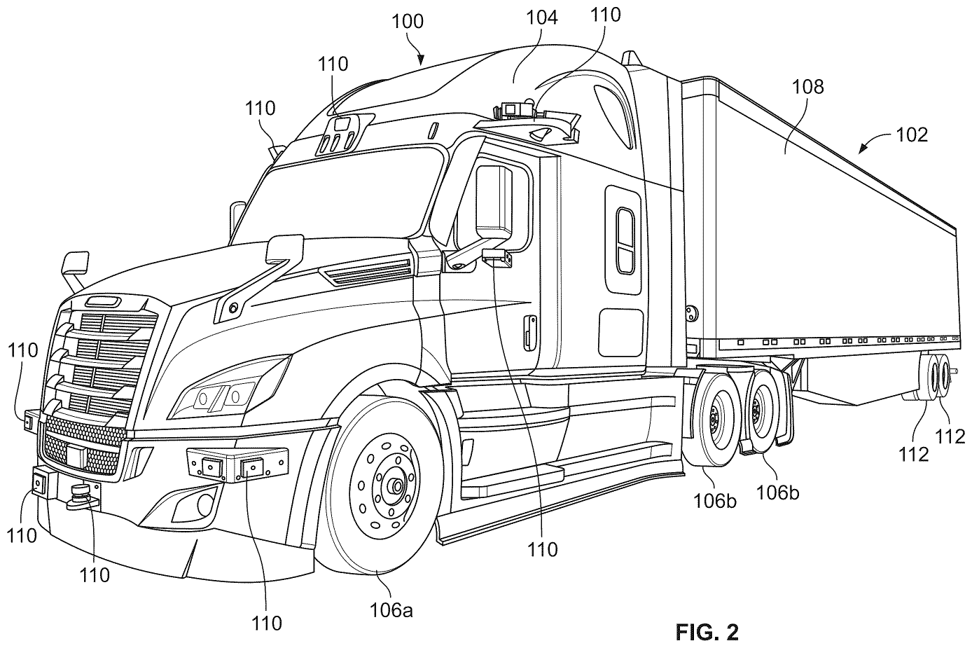

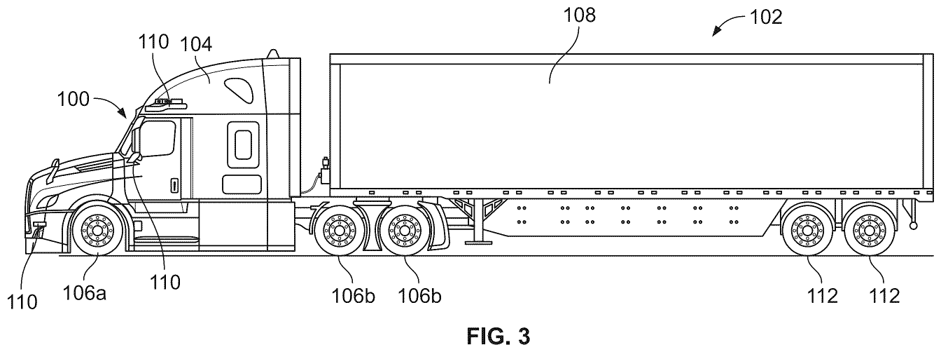

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

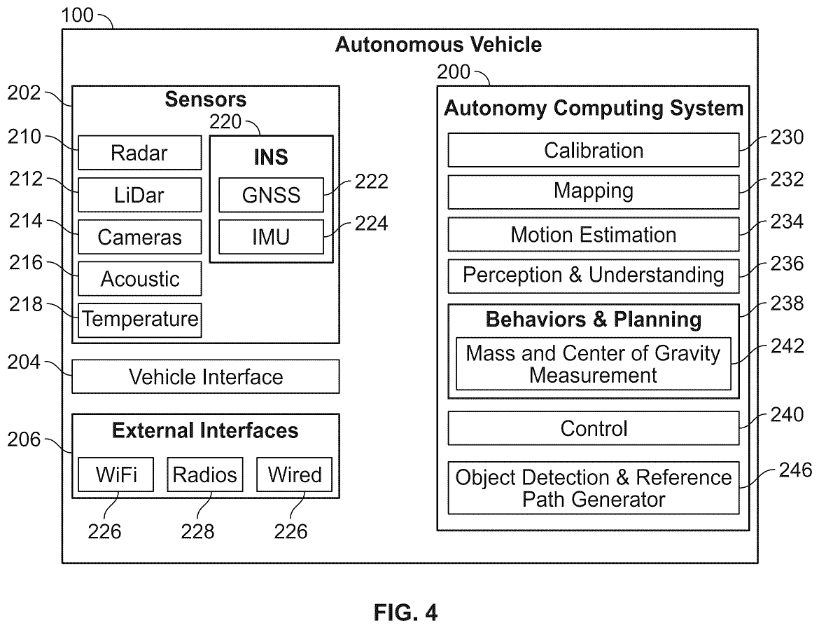

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

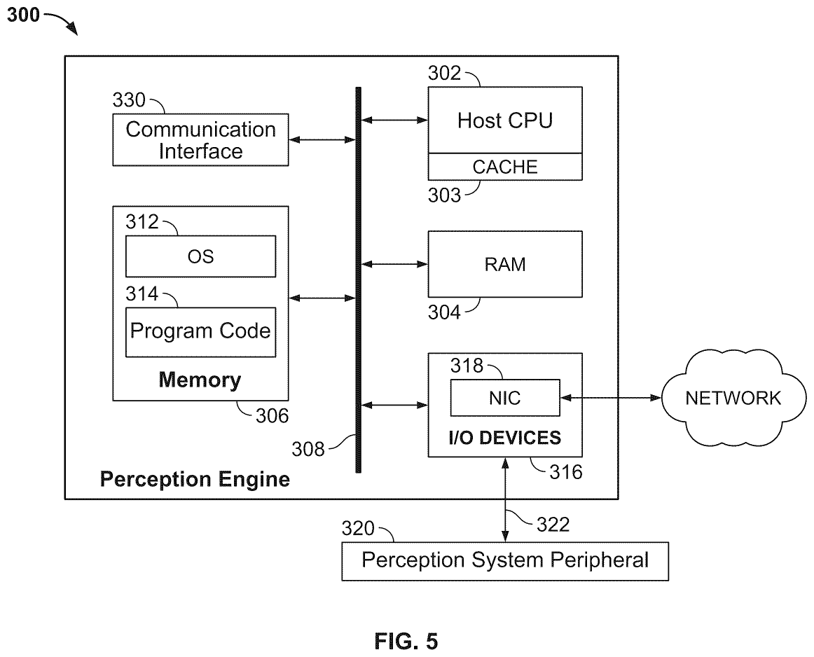

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

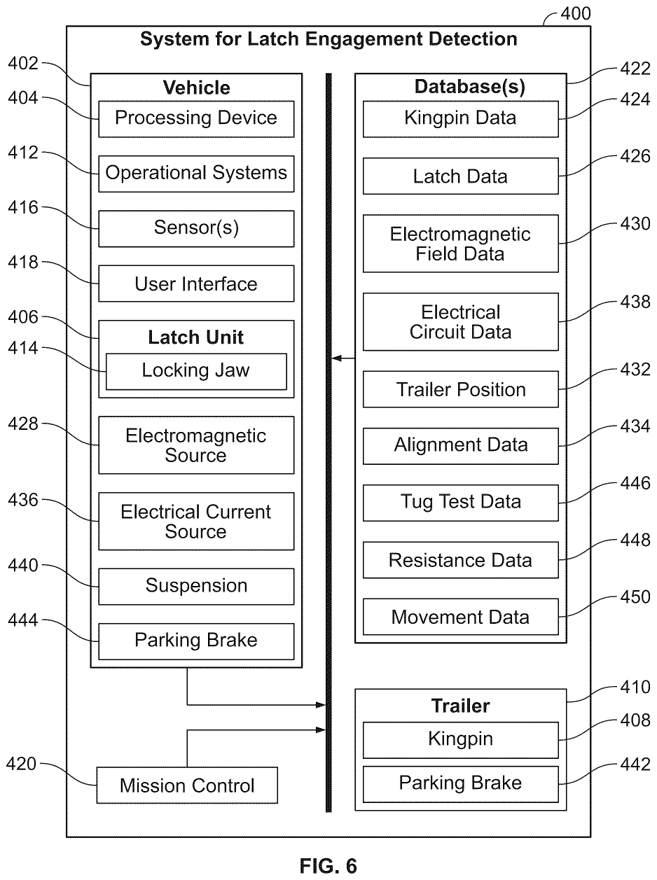

FIG. 6 is a block diagram of an exemplary system 400 for latch engagement detection. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data for engaging and verifying engagement of a latch unit 406 of the vehicle 402 with a kingpin 408 of a trailer 410. The vehicle 402 can include one or more operational systems 412 (e.g., mapping 232, motion estimation 234, perception and understanding 236, behaviors and planning 242, control 240, object detection and reference path generator 246, combinations thereof, or the like) for operating the vehicle 402 within an environment.

The operation system 412 assist the vehicle 402 in aligning with and reversing towards the trailer 410 such that the latch unit 406 can receive the kingpin 408 for engagement. After the kingpin 408 has been fully inserted into an interior section of the latch unit 406, a signal can be transmitted to the processing device 404 and the processing device 404 can actuate a locking jaw 414 of the latch unit 406 to secure the kingpin 408 in the latch unit 406.

The vehicle 402 can include one or more sensors 416 (e.g., sensors 202) for detecting the environment and objects within the environment around the vehicle 402, including the trailer 410 and the kingpin 408. For example, the sensors 416 can be used to detect the position of the trailer 410 relative to the vehicle 402 such that the vehicle 402 can be reversed and aligned with the trailer 410. The sensors 416 can ensure alignment of the latch unit 406 with the kingpin 408, such that the kingpin 408 can be received within the interior section of the latch unit 406 as the vehicle 402 continues to reverse towards the trailer 410. As discussed herein, the sensors 416 can detect electromagnetic and/or electrical current characteristics associated with the latch unit 406 to verify that the kingpin 408 has been inserted fully into the latch unit 406 and is ready for engagement with the locking jaw 414. In some embodiments, the sensors 416 can include proximity sensors. In some embodiments, the proximity sensors can include, e.g., capacitive sensors, inductive sensors, magnetic sensors, contact sensors, combinations thereof, or the like.

The vehicle 402 can include a user interface 418 (e.g., vehicle interface 204) configured to receive/transmit and display data for operation of the system 400, as well as the vehicle 402 itself. In some embodiments, the user interface 418 can display real-time images from the sensors 416 as the vehicle 402 reverses towards the trailer 410 for engagement of the kingpin 408 with the latch unit 406. In some embodiments, the user interface 418 can display real-time images from the sensors 416 of the kingpin 408 and latch unit 406. In some embodiments, the user interface 418 can display an alert regarding engagement of the kingpin 408 with the latch unit 406. In some embodiments, the user interface 418 can display an alert regarding unsuccessful engagement between the kingpin 408 and the latch unit 406, such that action can be taken by a driver and/or mission control 420 to address any potential alignment issues.

The system 400 can be used with any type of vehicle 402, e.g., autonomous, semi-autonomous, and/or non-autonomous. In some embodiments, mission control 420 can be in communication with the vehicle 402 and can remotely operate the vehicle 402 to perform the steps discussed herein, such as moving the vehicle 402 for engagement between the vehicle 402 and the trailer 410, detecting engagement between the vehicle 402 and the trailer 410, performing the tug test after engagement, combinations thereof, or the like.

The vehicle 402 can include one or more databases 422 (e.g., memory 306) configured to receive and electronically store data. In some embodiments, the database 422 can be stored externally from the vehicle 402 and the vehicle 402 can be in communication with the external database 422 for receiving and/or transmitting data associated with the system 400. In some embodiments, the database 422 can be located at mission control 420 (or at any other external location proximate a control unit) external to the vehicle 402 and in communication with the vehicle 402. In some embodiments, the database 422 can be located on the vehicle 402 itself. In some embodiments, one or more portions of the database 422 can be distributed across components of the system 400. The database 422 can store information relating to engagement between the latch unit 406 and the kingpin 408.

The latch unit 406 can be disposed on the rear chassis of the vehicle 402 and can include a fifth wheel plate. The latch unit 406 includes spaced arms that define a passage leading to an interior section of the latch unit 406 configured and dimensioned to receive the kingpin 408 of the trailer 410. The kingpin 408 can define a substantially vertically oriented post (relative to horizontal and the latch unit 406) extending from a surface of the trailer 410. The latch unit 406 receives a portion of the kingpin 408 in the latch unit 406 interior section as the latch unit 406 is reversed towards the trailer 410.

The locking jaw 414 of the latch unit 406 can be in the form of a selectively rotatable plate with an arm or flange configured to engage the kingpin 408 when the kingpin 408 is positioned in the interior section of the latch unit 406. The locking jaw 414 can be rotated into an open position which maintains the passage leading to the interior section of the latch unit 406 unobstructed such that the kingpin 408 can be inserted into the interior section, and a closed position which obstructs the passage into the interior section. In the closed position, the arm or flange of the locking jaw 414 blocks the passage into the interior section and prevents the kingpin 408 from passing out of the interior section of the latch unit 406.

The locking jaw 414 can be operated with the processing device 404 based on signals from the sensors 416 indicating that the kingpin 408 is in the interior section of the latch unit 406 and is ready for full engagement with the locking jaw 414. In particular, the vehicle 402 can include one or more detection units that detect movement of the kingpin 408 through the passage and into the interior section of the latch unit 406. The detection units can be used to detect movement of the locking jaw 414 into the closed position relative to the latch unit 406 structure. Signals from the detection units can be transmitted to the processing device 404 to indicate that engagement between the kingpin 408 and the latch unit 406 is successful, and the operational or tug test can be performed to verify the engagement.

Data from the sensors 416 can be transmitted and electronically stored in the database 422. The data associated with detection of the kingpin 408 can be electronically stored as kingpin data 424, and the data associated with detection of the latch unit 406 and/or the locking jaw 414 can be electronically stored as latch data 426. The data 424, 426 can be used by the processing device 404 to operate the vehicle 402 such that alignment between the kingpin 408 and the latch unit 406 is achieved. In some embodiments, the alignment process can be performed by the vehicle 402. In some embodiments, the vehicle 402 can be controlled remotely by mission control 420 during the alignment process to achieve alignment between the vehicle 402 and the trailer 410. Data associated with detection of the trailer 410 can be electronically stored as a trailer position 432, and data associated with alignment of the vehicle 402 relative to the trailer 410 can be stored as alignment data 434. The trailer position 432 can include the size and orientation of the trailer, for example. The alignment data 434 can include the orientation, angle, distance and/or height of the latch unit 406 relative to the kingpin 408.

In operation, the sensors 416 initially detect the position of the trailer 410 (e.g., trailer position 432) relative to the vehicle 402, and the latch unit 406 is aligned with the kingpin 408 of the trailer 410 (e.g., alignment data 434). After general or initial alignment is achieved, the processing device 404 releases air at a rear suspension 440 of the vehicle 402 to lower the rear chassis of the vehicle 402. The rear chassis is lowered selectively until the latch unit 406 is substantially vertically aligned with the kingpin 408 (e.g., relative to the road or surface on which the trailer 410 and vehicle 402 are located). After vertical and lateral alignment is substantially achieved, the vehicle 402 is autonomously reversed towards the trailer 410 to engage the kingpin 408 with the latch unit 406. The alignment process between the vehicle 402 and the trailer 410 can be performed more than one time if the vehicle 402 needs additional maneuvers to properly align with the trailer 410. The pressure in the air springs of the suspension 440 can be selectively adjusted during the alignment process to maintain the kingpin 408 aligned with the latch unit 406.

The latch unit 406 can include a body that defines a fifth wheel body or plate with the interior section. In some embodiments, the vehicle 402 can include an electromagnetic source 428 electrically connected to the fifth wheel plate of the latch unit 406. The electromagnetic source 428 generates an electromagnetic field in the passage of the latch unit, e.g., in the fifth wheel plate. Sensor(s) 416 and/or the electromagnetic source 428 can output electromagnetic field data 430, such as the magnitude of the electromagnetic field generated by the electromagnetic source 428, the rate of change of the electromagnetic field, combinations thereof, or the like.

The kingpin 408 and the latch unit 406 are fabricated from (or mostly from) metal. As a result, when the kingpin 408 passes through the opening in the latch unit 406 and into the interior section of the latch unit 406, the electromagnetic field generated by the electromagnetic source 428 changes. The sensors 416 are used to track the movement of the kingpin 408 into the interior section of the latch unit 406, and also track the change of the electromagnetic field in the passage of the latch unit 406, which is stored as the electromagnetic field data 430.

The processing device 404 receives the signals indicative of the change in the electromagnetic field, and thereby determines when the kingpin 408 is positioned fully within the interior section of the latch unit 406. In particular, a first electromagnetic field signal or level can indicate that the passage is free of the kingpin 408 (i.e., the kingpin 408 is spaced from the latch unit 406). A second electromagnetic field signal or level (different from the first electromagnetic field signal or level) can indicate that the kingpin 408 is partially within the passage of the latch unit 406. A third electromagnetic field signal or level (different from the first and second electromagnetic field signals or levels) can indicate that the kingpin 408 is fully within the passage of the latch unit 406 and is ready to be locked with the locking jaw 414.

The processing device 404 therefore receives real-time data regarding the position of the kingpin 408 relative to the latch unit 406. While the kingpin 408 is being aligned with and inserted into the interior section of the latch unit 406, based on the electromagnetic field data 430, the processing device 404 maintains the locking jaw 414 in the open position to ensure that the kingpin 408 is fully inserted into the interior section of the latch unit 406. When the electromagnetic field data 430 is indicative of the kingpin 408 being positioned fully in the interior section of the latch unit 406, the processing device 404 actuates the locking jaw 414 into the closed position to engage with the kingpin 408 and prevent passage of the kingpin 408 out of the latch unit 406. The electromagnetic field data 430 therefore functions as a feedback control loop for operation of the locking jaw 414. In some embodiments, one or more alternative sensors 416 (e.g., camera(s), light based sensor(s), ultrasonic sensor(s), combinations thereof, or the like) of the vehicle 402 can be used alone or in combination with the electromagnetic field data 430 to detect the position of the kingpin 408.

In some embodiments, the vehicle 402 can include an electrical current source 436. The electrical current source 436 can generate or pass an electrical current through the latch unit 406 and the locking jaw 414 to form a circuit, with the electrical current data 438 stored in the database 422. When the locking jaw 414 is in the open position, an arm or flange of the locking jaw 414 is spaced from an inner surface of the passage of the latch unit 406, resulting in an open circuit. When the locking jaw 414 is in the closed position, the arm or flange of the locking jaw 414 is positioned against the inner surface of the latch unit 406 (i.e., connecting opposing sides of the latch unit 406 across the passageway), resulting in a closed circuit.

The processing device 404 receives the electrical circuit data 438 in real-time during operation of the system 400. In particular, as the kingpin 408 is inserted into the interior portion of the latch unit 406 and the locking jaw 414 is in the open position, the processing device 404 receives signals indicating that the circuit is open. After the kingpin 408 has been inserted into the interior portion of the latch unit 406, the locking jaw 414 is actuated to move into the closed position. If repositioning of the locking jaw 414 into the closed position is successful, the arm or flange of the locking jaw 414 abuts the inner surface of the passage in the latch unit 406, thereby forming a closed circuit based on conductivity of the latch unit 406 and locking jaw 414 materials.

However, if the locking jaw 414 is obstructed by the kingpin 408 (or any other structure) and is unable to fully close, the electrical circuit remains open. Based on the electrical circuit data 438, the vehicle 402 is able to determine if the locking jaw 408 has been fully closed. If the electrical circuit data 438 shows a closed circuit, the processing device 404 can issue a signal indicating that the vehicle 402 is ready for the operational or tug test. If the electrical circuit data 438 shows an open circuit even after the locking jaw 414 has been actuated into the closed position, the processing device 404 generates a signal indicating that full engagement of the locking jaw 414 is not completed. The system 400 can take steps to position the locking jaw 414 into an open position and attempt to realign the kingpin 408 with the latch unit 406 before closing the locking jaw 414 again. If the electrical circuit remains open, the processing device 404 can transmit a signal or alert to mission control 420 indicating an inability to engage the kingpin 408 with the latch unit 406, and requesting assistance. It should be understood that any value or range of values for current and/or voltage can be used, with the system 400 determining whether or not a complete circuit is detected.

In some embodiments, detection of the kingpin 408 relative to the latch unit 406, and operation of the locking jaw 414 between the open and closed positions, can be performed remotely by mission control 420. After the kingpin 408 has been engaged with the latch unit 406 and the locking jaw 414 has been fully positioned in the closed position, the system 400 operates the vehicle 402 to perform an operational or tug test to ensure full engagement between the latch unit 406 and the kingpin 408. In some embodiments, the operational or tug test can be performed remotely by mission control 420. Data associated with the tug test can be stored as tug test data 446 based on data acquired from sensors 416. The processing device 402 engages a parking brake 442 of the trailer 410, and disengages a parking brake 444 of the vehicle 402 to allow for forward movement of the vehicle 402 away from the trailer 410.

In some embodiments, as the vehicle 402 moves away from the trailer 410, one or more sensors 416 can detect a resistance force on a power train of the vehicle 402. In particular, due to the parked position of the trailer 410, a force is exerted on the power train of the vehicle 402 as it tries to move away from the trailer 410. The measured resistance force can be stored in real-time as resistance data 448. The resistance data 448 includes a predetermined resistance threshold, and the processing device 404 compares the threshold value to the measured resistance force.

The threshold can represent a minimum resistance force value which represents that the kingpin 408 and the latch unit 406 are fully engaged. If the threshold value is reached or exceeded, the measured data indicates full engagement of the components. If the threshold value is not reached, the measured data indicates that engagement between the components is not complete. In such instances, the processing device 404 can issue an alert to mission control 420 requesting assistance, or can attempt a realignment and reengagement of the components before performing another tug test. In some embodiments, the threshold force value can be about, e.g., 30 kN, or the like, for a lightly loaded trailer on a concrete surface. However, it should be understood that the threshold force value or range can different depending on, e.g., the trailer weight, the road surface conditions, combinations thereof, or the like.

In some embodiments, in addition to or instead of the resistance data 448, the system 400 can rely on movement data 450 associated with the trailer 410 when performing the tug test. In particular, as the vehicle 402 moves away from the trailer 410 during the tug test, one or more sensors 416 can measure or detect movement of the trailer 410. Even with the parking brake 442 engaged, the trailer 410 moves a predetermined distance (e.g., a threshold distance value) due to the force exerted on the trailer 410 by the vehicle 402 via the latch unit 406.

The threshold therefore represents a minimum movement value or distance which represents that the kingpin 408 and the latch unit 406 are fully engaged. If the threshold movement value is reached or exceeded, the measured data indicates full engagement of the components. If the threshold movement value is not reached, e.g., the trailer 410 does not move at all, the measured data indicates that engagement between the components is not completed. In particular, no movement of the trailer 410 indicates that the trailer 410 is not receiving a force from the vehicle 402 and there is insufficient engagement between the components to exert the minimum force for movement of the trailer 410. In some embodiments, the minimum movement threshold can be about, e.g., 1-2 inches, or the like. However, it should be understood that the minimum movement threshold can differ depending on, e.g., the trailer weight, the road surface conditions, combinations thereof, or the like.

The system 400 therefore allows the vehicle 402 to autonomously and automatically engage the latch unit 406 with the kingpin 408, and further performs the tug test to verify that proper engagement of the components has been achieved. The autonomous and automatic operation of the system 400 provides an efficient process without human involvement. Accurate alignment and engagement of the components can be achieved, and safe deployment of the vehicle 402 on a mission route is permitted after the tug test is successfully completed.

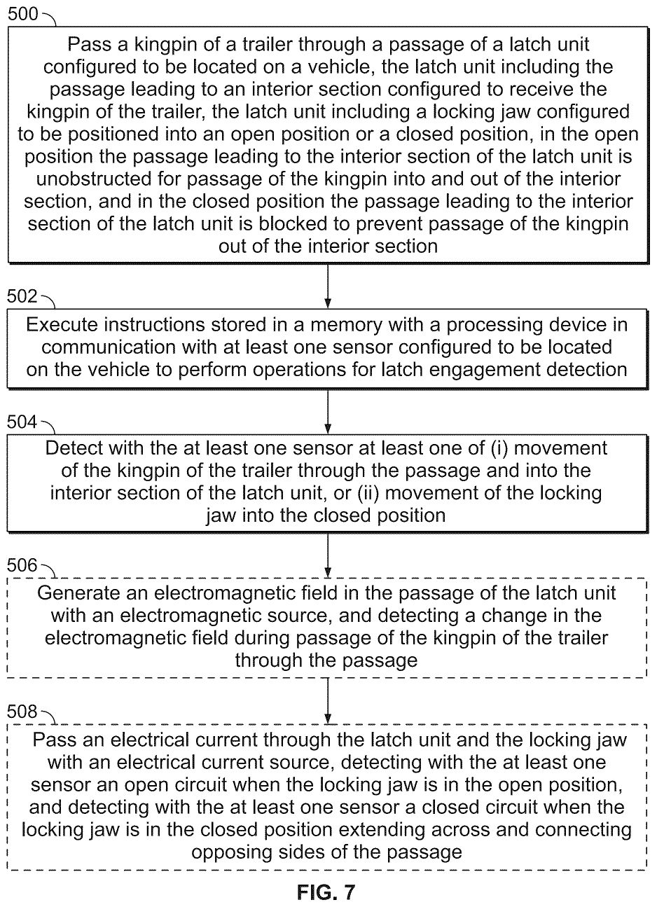

FIG. 7 is a flowchart of a method of latch engagement detection by the exemplary system 400 discussed herein. At 500, a kingpin of a trailer is passed through a passage of a latch unit configured to be located on a vehicle. The latch unit includes the passage leading to an interior section configured to receive the kingpin of the trailer. The latch unit includes a locking jaw configured to be positioned into an open position or a closed position. In the open position, the passage leading to the interior section of the latch unit is unobstructed for passage of the kingpin into and out of the interior section. In the closed position, the passage leading to the interior section of the latch unit is blocked to prevent passage of the kingpin out of the interior section.

At 502, instructed stored in a memory are executed with a processing device in communication with at least one sensor configured to be located on the vehicle to perform operations for latch engagement detection. At 504, at least one of movement of the kingpin of the trailer through the passage and into the interior section of the latch unit, or movement of the locking jaw into the closed position, is detected with at least one sensor of the vehicle. In some embodiments, at 506, an electromagnetic field is generated into the passage of the latch unit with an electromagnetic source. In such embodiments, a change in the electromagnetic field is detected during passage of the kingpin of the trailer through the passage. In some embodiments, at 508, an electrical current is passed through the latch unit and the locking jaw with an electrical current source. In such embodiments, an open circuit is detected with the sensor when the locking jaw is in the open position, and a closed circuit is detected with the sensor when the locking jaw is in the closed position extending across and connecting opposing sides of the passage.

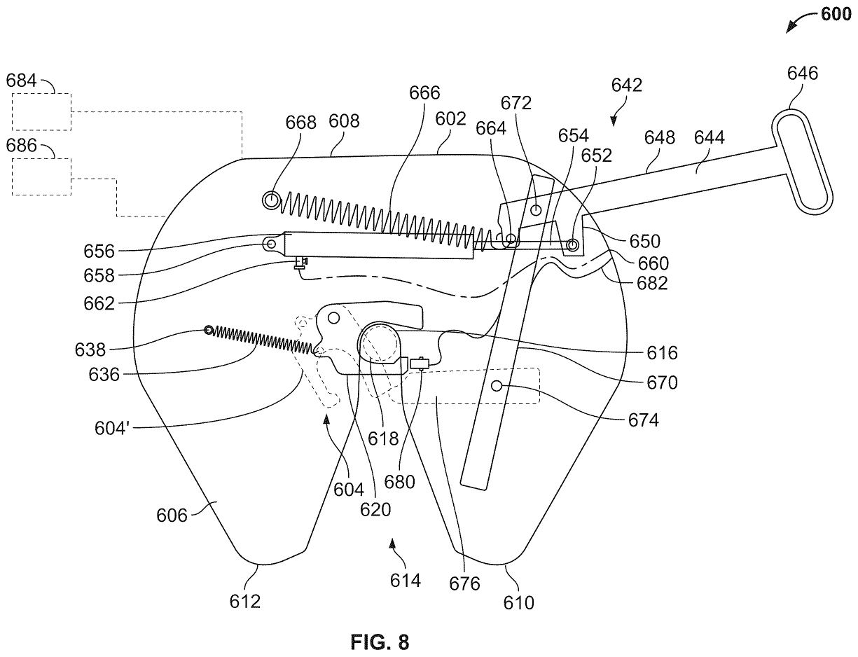

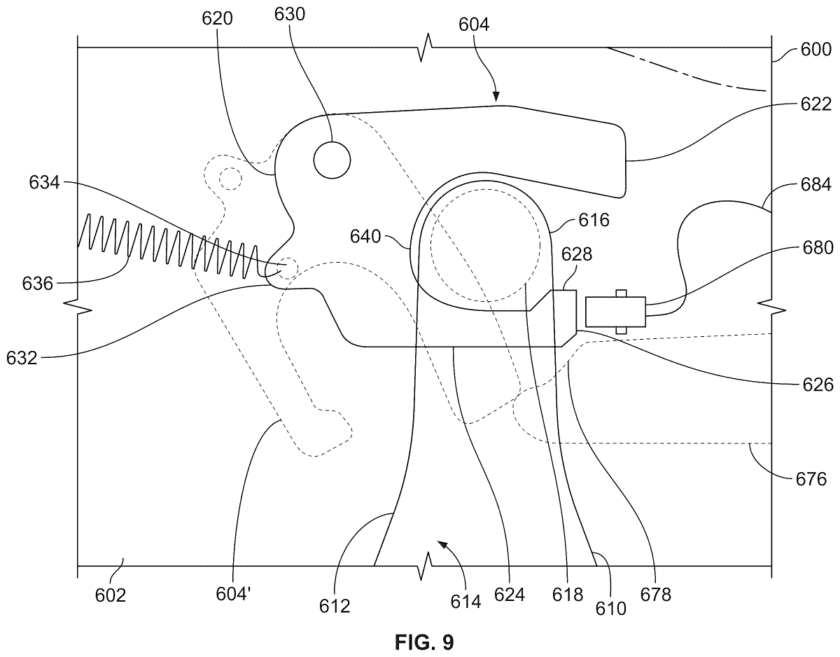

FIGS. 8 and 9 are diagrammatic top and detailed views of an exemplary latch unit 600 (e.g., latch unit 406) for implementation with the exemplary system 400 for latch engagement detection. The latch unit 600 includes a fifth wheel plate or body 602, and a locking jaw 604 rotatably coupled to the body 602. The body 602 can define a substantially planar top surface 606. The body 602 can define a generally circular or oval configuration along a rear side 608. The opposing, front side of the body 602 includes two arms or extensions 610, 612 spaced by a passage 614 leading to an interior portion 616 of the body 602. The interior portion 616 is configured to receive a kingpin 618 of a trailer.

The locking jaw 604 can define a substantially U-shaped body 620 with a flat or plate-like configuration. The body 620 can define a substantially curved edge on one end, and extensions or arms 622, 624 protruding from the body 620 on the opposing end. The arms 622, 624 extend substantially parallel to each other and define a gap through which the kingpin 618 can pass when the locking jaw 604 is in the open position. In some embodiments, an endpoint 626 of the arm 624 can include an inwardly extending flange 628, extending towards the arm 622. Between the arms 622, 624, the locking jaw 604 includes a rounded innermost surface 640 configured to engage with the kingpin 618. The surface 640 is therefore substantially complementary to the kingpin 618.

The flange 628 helps to lock and maintain the position of the kingpin 618 when the locking jaw 604 is in the closed position (shown in solid lines in FIGS. 8 and 9). The locking jaw 604′ is shown in the open position, with the arm 622 partially in the passage 614. In the open position, the locking jaw 604′ allows for movement of the kingpin 618 through the passage 614.

The locking jaw 604 can be coupled at a pivot point 630 at or near the rounded edge of the body 620, allowing the locking jaw 604 to be rotated between the open and closed positions. The rounded edge of the body 620 can include an extension 632 with a coupling point 634 to which an end of a tension spring 636 can be coupled. The opposing end of the spring 636 can be coupled to a coupling point 638 on the extension 612 of the body 602.

The spring 636 can bias the locking jaw 604 into the open position (e.g., locking jaw 604′). As the kingpin 618 is moved into the passage 614 and abuts the arm 622 in the passage 614, the force from the kingpin 618 expands the spring 636 and pivots the locking jaw 604 into the closed position. In the closed position, the kingpin 618 is positioned in the interior portion 616 of the latch unit 600, and against or adjacent to the rounded innermost surface 640 of the locking jaw 604. In the closed position, the arm 626 extends fully across the passage 614, blocking or obstructing the passage 614 to prevent disengagement of the kingpin 618 from the latch unit 600.

The latch unit 600 includes a spring-loaded release handle assembly 642 configured to engage with the locking jaw 604 to selectively maintain or release the locking jaw 604 from the closed position. The assembly 642 can be in the form of a linkage assembly. The assembly 642 includes a release handle 644 with a grip 646, a linkage 648 extending from the grip 646, and a flange 650 extending perpendicularly near an opposing end of the linkage 648 (relative to the grip 646). The linkage 648 includes a coupling point 652 for rotatable connection to a rod 654 of an electronic or pneumatic piston 656. The piston 656 is coupled at an opposing end 658 to the body 602. An electrical or compressed air line 660 connects to the piston 656 via a coupler 662. The endpoint of the linkage 648 includes a coupling point 664 which receives an end of a tension spring 666. The opposing end of the spring 666 connects to the body 602 at a coupling point 668. The spring 666 biases the linkage 648 in the clockwise direction.

The assembly 642 includes a second linkage 670 rotatably connected at one end to the linkage 648 at a coupling point 672 disposed between the flange 650 and the coupling point 664 on the linkage 648. The opposing end of the linkage 670 rotatably couples to a lock bar 676 at a coupling point 674. The coupling point 676 further rotatably couples the linkage 670 and lock bar 676 to the body 602. The opposing end of the lock bar 676 defines a curved face 678 configured to engage with the arm 624 of the locking jaw 604 to maintain the locking jaw 604 in the closed position (as shown in FIG. 9). The linkage assembly 642 can be selectively operated to maintain the lock bar 676 in the engaged position to keep the locking jaw 604 in the closed position, or can be operated to pivot the lock bar 676 out of position and release the locking jaw 604 to the open position.

The latch unit 600 can include a sensor 680 disposed on the body 602 and adjacent to the endpoint 626 of the arm 624 of the locking jaw 604 when the locking jaw 604 is in the closed position. The sensor 680 can be part of a detection system that detects when the locking jaw 604 is in the closed position. The sensor 680 can be electrically coupled via a cable 682 (or wirelessly coupled) to a processing device of the vehicle such that data from the sensor 680 can be communicated to the processing device for selective operation of the vehicle, e.g., to perform an operational or tug test when the locking jaw 604 is closed.

In some embodiments, the latch unit 600 can be connected to an electromagnetic source 684 and/or an electrical current source 686 (e.g., electromagnetic source 428 and/or electrical current source 436) for detection of the kingpin 618 position relative to the interior portion 616 of the body 602, and for detecting when the locking jaw 604 is fully closed. In some embodiments, part of the structure of the body 602 can be wrapped with wire to transform the body 602 into an inductor. In some embodiments, the wire can be position on the main plate of the body 602 and another wire can be positioned on the lock bar 676, such that when the lock bar 676 is moved into position, the circuit is completed. As previously described, the electromagnetic source 684 can generate an electromagnetic force in the passage 614 between the arms 610, 612. Due to the conductive nature of the arms 610, 612 and the kingpin 618, as the kingpin 618 moves through the passage 614 towards the interior portion 616, the electromagnetic field or force changes. The sensor 680 can detect the change in the electromagnetic force and, based on this change, determines when the kingpin 618 has been fully positioned within the interior portion 616.

As previously described, the electrical current source 686 generates an electrical current in the body 602 to form a circuit across the passage 614. When the locking jaw 604′ is in the open position, the endpoint 626 is spaced from the inner surface of the arm 610 and the circuit is open. When the locking jaw 604 is in the closed position, the endpoint 626 sits over and against, or in direct contact with the inner surface of the arm 610, and the circuit is closed. The closed or open circuit status can be communicated to the processing device of the vehicle to indicate if the locking jaw 604 has been fully closed.

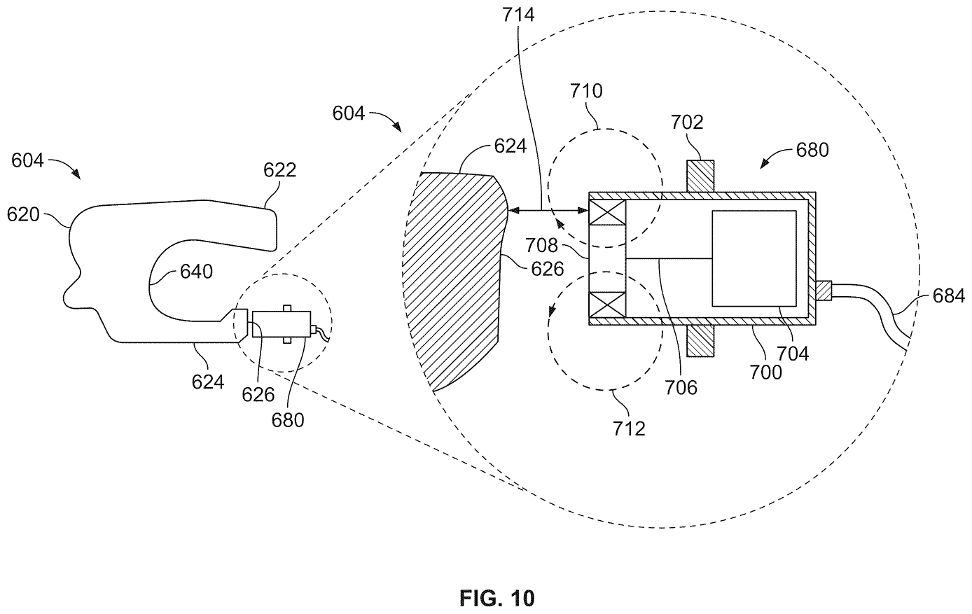

The sensor 680 of FIGS. 8 and 9 can be, e.g., a capacitive sensor, an inductive sensor, a magnetic sensor, a contact sensor, or the like. FIG. 10 shows the sensor 680 in the form of an electromagnetic sensor. The sensor 680 includes a housing 700 that encases electrical components associated with the sensor 680. The sensor 680 can include a mounting flange 702 extending from the housing 700, which allows the sensor 680 to be mounted to the body 602 of the latch unit 600 (see FIGS. 8 and 9). The sensor 680 includes an internal circuit 704 connected with wiring 706 to a current coil 708 (e.g., a sensing/eddy current coil).

The current coil 708 is operated with the internal circuit 704 to generate magnetic fields 710, 712 at the front face of the sensor 680 and, particularly, in the gap between the sensor 680 and the endpoint 626 of the arm 624 of the locking jaw 604. When the locking jaw 604 is in the open position, the endpoint 626 is spaced from the sensor 680 and the conductive material of the endpoint 626 does not change the magnetic field 710, 712 generated by the sensor 680. The lack of change in the magnetic field 710, 712 indicates (via a signal from the sensor 680) that the locking jaw 604 is not in the closed position.

When the locking jaw 604 is rotated into the closed position (as shown in FIG. 10), the endpoint 626 is disposed within a predetermine distance 714 of the sensor 680 and the magnetic field 710, 712 is varied or affected due to the conductive material of the endpoint 626. The detected change in magnetic field 710, 712 is indicative of the locking jaw 604 being in the closed position, and a representative signal can be transmitted by the sensor 680 to the processing device to confirm that the locking jaw 604 is in the closed position. As a result, an automated detection of the locking jaw 604 position can be made.

It should be understood that, in some embodiments, the same type of electromagnetic sensor 680 can be used to detect when the kingpin 618 has been positioned in the interior portion 616 of the latch unit 600. The sensor 680 can generate the magnetic fields 710, 712 which extend across the passage 614. As the kingpin 618 moves through the passage 614, the conducive material of the kingpin 618 affects the magnetic field 710, 712. The change in magnetic field 710, 712 is detected by the sensor 680, which transmits the change to the processing device of the vehicle to indicate that the kingpin 618 is in the passage 614. The change in the magnetic field 710, 712 can be used to detect the direction of movement of the kingpin 618 in the passage 614, as well as when the kingpin 618 is fully in the interior portion 616. As a result, an automated detection of the kingpin 618 position can be made.

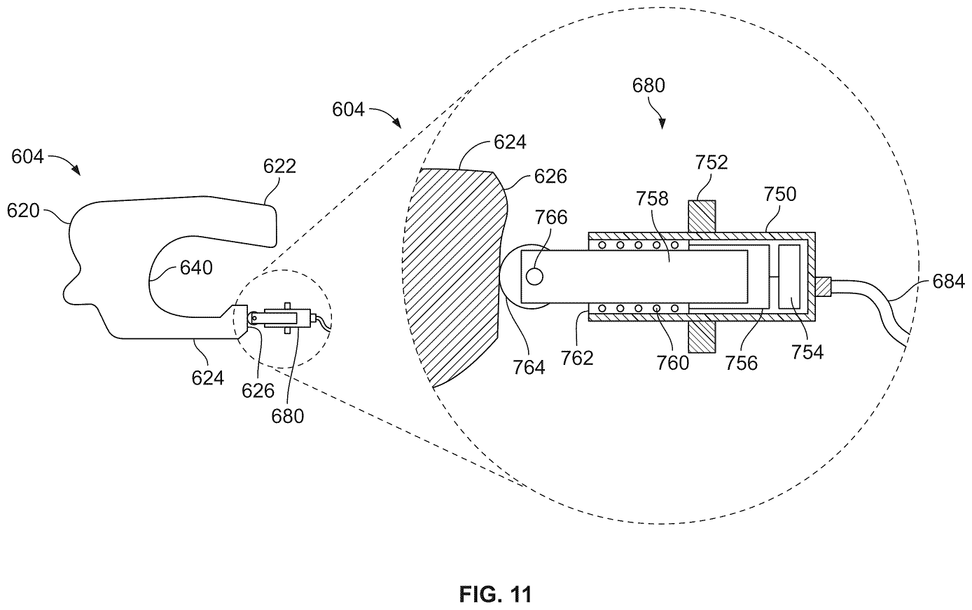

FIG. 11 illustrates the sensor 680 in the form of a contact sensor. The sensor 680 of FIG. 11 includes a housing 750 with a mounting flange 752 for coupling the sensor 680 to the body 602. The sensor 680 includes an internal circuit 754 electrically connected to a sensing coil 756. The sensor 680 includes a probe core 758 movably disposed within the housing 750 and abutting the sensing coil 756. A spring 760 biases the probe core 758 outward from the front end 762 of the housing 750. A contact roller 764 is rotatably coupled at a coupling point 766 to the endpoint of the probe core 758 outside of the housing 750.

In operation, when the locking jaw 604 is in the open position, the endpoint 626 is spaced from the contact roller 764 and the signal from the sensing coil 756 remains uniform. When the locking jaw 604 is rotated into the closed position, the endpoint 626 contacts the contact roller 764 and applies a predetermined inward pressure on the contact roller 764, thereby compressing the spring 760. The inward pressure is detected by the sensing coil 756, which transmits the pressure to the internal circuit 754. The internal circuit 754 transmits a signal to the processing device of the vehicle to indicate that the locking jaw 604 is in the closed position based on the change in pressure detected by the sensing coil 756. As a result, an automated detection of the locking jaw 604 position can be made.

It should be understood that, in some embodiments, the same type of contact sensor 680 can be used to detect when the kingpin 618 is within the interior portion 616 of the latch unit 600. For example, the contact roller 764 can be disposed perpendicularly to the interior portion 616 such that when the kingpin 618 is fully within the interior portion 616, the kingpin 618 imparts a force on the contact roller 764. The force on the contact roller 764 is transmitted to the sensor 680, which transmits a signal to the processing device of the vehicle to indicate that the kingpin 618 is in position. As a result, an automated detection of the kingpin 618 position can be made.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for latch engagement detection, comprising:
a latch unit configured to be located on a vehicle, the latch unit including a passage leading to an interior section configured to receive a kingpin of a trailer;
a locking jaw of the latch unit configured to be positioned into an open position or a closed position, wherein in the open position the passage leading to the interior section of the latch unit is unobstructed for passage of the kingpin into and out of the interior section, and wherein in the closed position the passage leading to the interior section of the latch unit is blocked to prevent passage of the kingpin out of the interior section;
at least one sensor configured to be located on the vehicle; and
a processing device in communication with the at least one sensor, wherein the processing device is configured to execute instructions stored in a memory to perform operations comprising:
detecting with the at least one sensor at least one of (i) movement of the kingpin of the trailer through the passage and into the interior section of the latch unit, or (ii) movement of the locking jaw into the closed position.

2. The system of claim 1, comprising an electromagnetic source connected to a fifth wheel body of the latch unit and configured to generate an electromagnetic field in the passage of the latch unit.

3. The system of claim 2, wherein movement of the kingpin of the trailer through the electromagnetic field in the passage of the latch unit changes the electromagnetic field.

4. The system of claim 3, wherein detecting with the at least one sensor movement of the kingpin of the trailer through the passage and into the interior section of the latch unit comprises detecting a change in the electromagnetic field as the kingpin moves through the electromagnetic field.

5. The system of claim 4, wherein a first electromagnetic field signal is indicative of the passage being free of the kingpin, a second electromagnetic field signal is indicative of the kingpin being partially positioned within the passage and spaced from the interior section, and a third electromagnetic field signal is indicative of the kingpin being positioned in the interior section of the latch unit.

6. The system of claim 5, wherein upon detection with the at least one sensor the third electromagnetic field signal, the operations comprise actuating the locking jaw into the closed position to prevent passage of the kingpin out of the interior section.

7. The system of claim 1, comprising an electrical current source passing an electrical current through the latch unit and the locking jaw to form a circuit.

8. The system of claim 7, wherein the operations comprise detecting with the at least one sensor an open circuit when the locking jaw is in the open position, and detecting with the at least one sensor a closed circuit when the locking jaw is in the closed position extending across and connecting opposing sides of the passage.

9. The system of claim 1, wherein the at least one sensor is a proximity sensor including at least one of a capacitive sensor, an inductive sensor, a magnetic sensor, or a contact sensor.

10. The system of claim 1, wherein the operations comprise detecting with the at least one sensor a trailer position relative to the vehicle, and aligning the latch unit of the vehicle with the kingpin of the trailer.

11. The system of claim 10, wherein the at least one sensor is at least one of a camera, or LiDAR.

12. The system of claim 10, wherein upon alignment of the latch unit of the vehicle with the kingpin of the trailer, the operations comprise releasing air at a rear suspension of the vehicle to lower a rear chassis of the vehicle.

13. The system of claim 12, wherein the operations comprise autonomously reversing the vehicle towards the trailer until the at least one sensor detects the movement of the kingpin of the trailer through the passage and into the interior section of the latch unit.

14. The system of claim 13, wherein upon detection with the at least one sensor the movement of the kingpin of the trailer through the passage and into the interior section of the latch unit, the operations comprise actuating the locking jaw into the closed position to prevent passage of the kingpin out of the interior section of the latch unit.

15. The system of claim 1, wherein upon detection with the at least one sensor the movement of the kingpin of the trailer through the passage and into the interior section of the latch unit, the operations comprise actuating the locking jaw into the closed position to prevent passage of the kingpin out of the interior section of the latch unit.

16. The system of claim 15, wherein the operations comprise performing a tug test by operating the vehicle to move away from the trailer while a parking brake on the vehicle is released and a parking brake on the trailer is engaged, detecting with the at least one sensor a resistance force on a power train of the vehicle, and comparing the detected resistance force to a predetermined resistance threshold to determine whether engagement between the latch unit and the kingpin is secure.

17. The system of claim 15, wherein the operations comprise performing a tug test by operating the vehicle to move away from the trailer, detecting with the at least one sensor movement of the trailer, and comparing the detected movement of the trailer relative to a predetermined movement threshold.

18. A computer-implemented method for latch engagement detection, comprising:
passing a kingpin of a trailer through a passage of a latch unit configured to be located on a vehicle, the latch unit including the passage leading to an interior section configured to receive the kingpin of the trailer, wherein the latch unit includes a locking jaw configured to be positioned into an open position or a closed position, wherein in the open position the passage leading to the interior section of the latch unit is unobstructed for passage of the kingpin into and out of the interior section, and wherein in the closed position the passage leading to the interior section of the latch unit is blocked to prevent passage of the kingpin out of the interior section; and
executing instructions stored in a memory with a processing device in communication with at least one sensor configured to be located on the vehicle to perform operations comprising:
detecting with the at least one sensor at least one of (i) movement of the kingpin of the trailer through the passage and into the interior section of the latch unit, or (ii) movement of the locking jaw into the closed position.

19. The method of claim 18, wherein the operations comprise generating an electromagnetic field in the passage of the latch unit with an electromagnetic source, and detecting a change in the electromagnetic field during passage of the kingpin of the trailer through the passage.

20. The method of claim 18, wherein the operations comprise passing an electrical current through the latch unit and the locking jaw with an electrical current source, detecting with the at least one sensor an open circuit when the locking jaw is in the open position, and detecting with the at least one sensor a closed circuit when the locking jaw is in the closed position extending across and connecting opposing sides of the passage.
